(19) United States
(12) Patent Application Publication
(10) Pub. No.: US 2009/0283331 A1
(43) Pub. Date: Nov. 19, 2009

(54) MATERIAL FOR PRODUCING PARTS OR COATINGS ADAPTED FOR HIGH WEAR AND FRICTION-INTENSIVE APPLICATIONS, METHOD FOR PRODUCING SUCH A MATERIAL AND A TORQUE-REDUCTION DEVICE FOR USE IN A DRILL STRING MADE FROM THE MATERIAL

(76) Inventor: Gary Heath, Corseaux (CH)

Correspondence Address: Horst M. Kasper, 13 Forest Drive, Warren, NJ, 07059, US

(21) Appl. No.: 12/084,818

(22) PCT Filed: Nov. 6, 2006
(86) PCT No.: PCT/EP2006/068112

§ 371 Date: May 8, 2008

(30) Foreign Application Priority Data
Nov. 22, 2005 (EP) 05025414.3

(51) Int. Cl. E21B 17/10; C09K 3/14; E21B 17/00

(52) U.S. Cl. 175/325.2; 106/36

(57) ABSTRACT

The present invention relates to a material for producing parts or coatings adapted for highly wear and friction intensive applications, said material comprising preformed hard material particles made of carbides which are randomly embedded in a matrix of a host material. In order to provide a material that is suitable to produce parts or coatings having a high wear resistance, and which at the same time causes a low friction resistance, it is suggested that the carbide particles are preformed spherical particles having a hardness in the range between 1000 and 2000 HV/10 and said host material is a Ni based alloy additionally comprising C, Cr, Mo, Fe, Si, B and Cu in the following ranges (in wt %): C 0.005-1.0; Cr 10.0-26.0; Mo 8.0-22.0; Fe 0.1-10.0; Si 3.0-9.0; B 1.0-5.0; Cu 0.1-5.0.

The present invention relates to a material for producing parts or coatings adapted for highly wear and friction intensive applications, said material comprising preformed hard material particles made of carbides which are randomly embedded in a matrix of a host material.

Furthermore, the invention relates to a method for producing a material adapted to form such parts or coatings by providing a mixture of raw material in powder form or wire form comprising preformed hard material particles and a host material, and subsequent melting of the raw material.

Furthermore this invention relates to a torque-reduction device for use in a drill string, comprising a generally cylindrical body adapted to form part of a drill string, said body including a torque-reducing contact surface.

The drilling of holes or bores into underground formations and particularly, the drilling of oil and gas wells, is typically accomplished using an elongated “drill string” which initially carries the drill bit or other cutting tool, and which is constructed from a number of sections of tubular drill pipe which are coupled at their ends. The drill string extends from the drilling surface into a well or “wellbore”, which is formed by the rotating drill bit. As the drill bit penetrates deeper or further into an underground formation, additional sections of drill pipe are added to the drill string.

It is conventional practice to line the wall of a bore hole with steel piping as the length of that bore hole progressively increases. This steel piping is generally known as a bore hole “casing”. The casing lines the bore to prevent the wall from caving in and to prevent seepage of fluids from the surrounding formations from entering the wellbore. The casing also provides a means for recovering the gas or the oil if the well is found to be productive. The lining of the bore can be strengthened by introducing cement between the external surface of the casing and the internal surface of the well bore.

A drill string can eventually have a considerable length, and it is relatively flexible, being subject to lateral deflection, especially at the regions between joints or couplings. In particular, the application of weight onto the drill string or resistance from the drill bit can cause axial forces which in turn can cause lateral deflections. These deflections can result in portions of the drill string contacting the casing. In addition, the drilling operation may be along a curved or angled path, commonly known as “directional drilling”. Such directional drilling, especially, causes frequent contact between portions of the drill string and the casing.

Contact between the drill string and the casing creates frictional torque and drag. In fact, a considerable amount of torque can be produced by the effects of frictional forces developed between the rotating drill string and the casing. During drilling operations, additional torque is required while rotating the drill string to overcome this resistance.

It will immediately be realized that the drill string, which frequently contacts the surrounding bore hole casing, inevitably causes frictional wear, increased shock and abrasion to itself, and similar wear or other damage to the surrounding casing. If the frictional wear continues, the casing is worn thin by frictional contact with the rotating drill string pipe and will eventually rupture. A shut-down of the drilling operation is consequently then necessary, with lengthy and expensive remedial work being required before the casing is restored to a fully effective condition. Frequently, the length of productive life of a well is determined substantially wholly by the duration of the integrity of its bore hole casing.

In this context it should be noted that there is the wear between the drill string and the casing but there is also wear from the passing abrasive slurry from the drill head. This slurry will get between the drill string and the casing and cause wear of each even if they are not in direct contact.

Various attempts have been made to eliminate or reduce the frictional wear discussed above by providing drill pipe protectors along the length of the drill pipe string. These protectors were made from sleeves of rubber or other elastomeric material, and were placed over the drill pipe to keep the drill pipe and its connections away from the wall of the casing. Rubber or other elastomeric materials were used because of their ability to absorb shock and impart minimal wear. Protectors of this type are described in U.S. Pat. No. 5,069,297 A. The protector comprises a generally annular body that surrounds the drill pipe and is free to rotate with respect thereto. The outer diameter of the protector is greater than the maximum outer diameter of the connecting portions of the drill pipe, and less than the inside diameter of the casing. In the event that the protector contacts the surface of the casing, the drill pipe may still rotate freely within the protector. This minimizes the increases in torque or drag which would otherwise be caused by contact between the pipe string and the casing, and reduces the likelihood of damage being caused to either the pipe or casing thereby.

Devices of this type perform an additional function in stabilizing the drill string and thereby reducing vibration of the string in use. However, when using such drill pipe protectors, they can produce a significant increase in the rotary torque developed during drilling operations. In instances where there may be hundreds of these protectors in the wellbore at the same time, they can generate sufficient accumulative torque or drag to adversely affect drilling operations.

WO 01/59249 A2 discloses a modification of a torque-reduction and/or protection device for use in a drill string. It is suggested that the drill string, or a part of it, is formed from rigid alloys provided with low friction bearing means between the drill string and the casing. The low friction bearing means may be coatings or inserts made of a low friction alloy, low friction ceramic or magnetic elements. For example, a low friction alloy insert could be formed from steel with ceramic elements inserted therein.

Suitable alloys to give protection from wear and corrosion have long been known. For example, Nickel-based alloys with additives of chromium and molybdenum are successfully involved in many branches of industry for the purposes of thermal spraying and welding, as described in U.S. Pat. No. 6,027,583 A and in U.S. Pat. No. 6,187,115 A.

In a paper titled “Hardbending for Drilling Unconsolidated Sand Reservoirs”, presented at the IADC/SPE Asia Pacific Drilling Technology” held in Jakarta, 9-11 Sep. 2002, by J. Barrios, C. Alonso, E. Pedersen, A. Bachelot and A. Broucke, it is reported that tungsten carbide grains are used to prepare tungsten carbide-steel composites in order to increase the hardness of hardbending material applied to a contact surface of a drill string. The tungsten carbide grains shall resist melting and alloying during welding of the hardbending. Steel is used as a-matrix material for merely stick the tungsten carbide grains on the contact surface. Instead of steel other matrix materials in form of alloys were tested and it was found that the harder the matrix material the higher the wear resistance in tungsten carbide hardbending materials.

However, it has been found that the known coating materials are not totally effective with respect to torque reduction. Preformed tungsten carbide particles are very hard and they tend to damage any material coming into contact with.

It is therefore an object of the present invention to provide a material that is suit-able to produce parts or coatings having a high wear resistance, and which at the same time causes a low friction resistance.

It is a further object of the present invention to provide a torque-reduction device for use in a drill string, which prevents both the bore hole casing and the drill string from experiencing severe damage in case of a contact.

It is further aspect of the invention to provide a method being suitable for applying the material according to the invention on a contact surface in order to prepare hardbending.

With respect to the material for producing parts or coatings adapted for highly wear and friction intensive applications, this object is achieved according to the invention in that said material comprising preformed hard material particles made of made of carbides which are randomly embedded in a matrix of a relatively soft host material, wherein said carbide particles are preformed spherical particles having a hardness in the range between 1000 and 2000 HV/10 and said host material is a Ni based alloy additionally comprising C, Cr, Mo, Fe, Si, B, and Cu in the following ranges (in wt %):

| | |
|---|---|
| C | 0.005-1.0 |
| Cr | 10.0-26.0 |
| Mo | 8.0-22.0 |
| Fe | 0.1-10.0 |
| Si | 3.0-9.0 |
| B | 1.0-5.0 |
| Cu | 0.1-5.0 |

Here, the unit “HV10” represents the so called “Vickers hardness”, evaluated by using a Vickers hardness testing machine applying a 10 kg force. The method for measuring hardness according to Vickers is specified in DIN EN ISO 6507-1. Testing methods for the evaluation of the micro hardness of metallic coatings are specified in DIN ISO 4516. To convert a Vickers hardness number in MPa (SI unit) a multiplication by 9.807 is suitable.

The material according to the invention is characterized by a host material as specified above, which forms a relatively soft matrix when compared to the hard-ness of the preformed carbide particles embedded therein. Nickel makes up the balance of the composition given above besides non-avoidable impurities; optional components of minor relevance may be included. The use of Ni-based alloys with additives of chromium and molybdenum to give protection from wear and corrosion has long been known. Such alloys are disclosed for example in the above-cited U.S. Pat. No. 6,027,583 A, U.S. Pat. No. 6,187,115 A and U.S. Pat. No. 6,322,857 A. The alloys show an improved resistance to wear and corrosion, however such alloys are relatively soft so that such material has not been considered to be beneficial for torque reduction. Therefore, it is especially relevant that in the host material hard spherical carbide particles are embedded therein. Due to a regular frictional contact with any structural member the relative soft host material is gradually abraded until ultimately some of the hard particles project through the surface. Consequently, the contact area between the structural member and the material according to the invention is reduced, resulting in a low coefficient of friction.

In order to avoid damage of structural members coming into contact with the surface of the material according to the invention, it has been found crucial that in case of hard particles in form of carbides these are made of preformed carbide particles dispersed in the host material. Due to the spherical shape of the hard particles the damage to the structural member is minimized. On the other hand, the hard particles themselves substantially withstand any abrasion, thus contributing to a high wear resistance of the material, all in all. Furthermore, in case of a contact with a structural member, the relative soft matrix composition works generally as a buffer, and prevents severe damage of the structural member, as well as of the material itself and the parts adjacent to it.

However, it has been found that parts or coatings containing preformed tungsten carbide particles—as in the known materials mentioned above—are damaging any contacting material due to the hardness of the tungsten carbide particles embedded therein. The Vickers hardness of tungsten carbide particles is about 2200 HV/10. Considerably better results in view of torque reduction and damage behavior were found with a material including preformed carbide particles whose hardness is respectively low, namely in the range between 1000 and 2000 HV/10 in combination with a host material as specified above.

It may occur that carbides precipitate from a melt containing or a solid solution containing large quantities of carbon. However, it was found that a certain quantity of such carbide precipitates in the material can be allowed. However, best results were found if all or at least the greatest part the hard carbide particles are preformed spherical particles dispersed in the host material.

The result is a material having a high wear resistance and a low coefficient of friction on one side and a low susceptibility to damage on the other hand. Such materials are suitable for providing wear resistant and low torque surfaces especially for hardbending wear plates, downhole tools, chain conveyors or transport screws.

The preformed spherical particles are made of carbides. Carbides of titanium, zirconium, hafnium, vanadium, niobium, tantalum, chromium and molybdenum are thermodynamically stable, chemically resistant, and form very hard particles. However, as explained above, some of these carbides are too hard to give very good results in wear resistant and low frictional coatings.

Therefore, in a preferred embodiment the preformed carbide particles have a hardness lower than 1800 HV/10.

The lower the hardness of the hard particles, the better the damage behavior in view of any contacting material.

Chromium carbides are most preferred in this respect.

The Vickers hardness of chromium carbide (CrC) is in the range between 1100 and 1600 HV/10, depending on the kind and amount of metal phase included in the particles. A material in which most or all of the hard particles consist of CrC is showing a low friction and a good damage behavior due to the relatively low hard-ness of the hard particles. Additionally, chromium carbide is a composition, which does not tend to form oxides under conditions of high temperature and friction. Therefore, which is also a property contributing to a low frictional behavior.

The relative hardness of the CrC particles compared to the matrix is important, because the use of a “softer” matrix, allows the CrC particles to “stand proud” of the surface and act as the contact points.

A host material having a hardness in the range of 35 HRC to 60 HRC has been found favorable.

Here, the unit “HR” represents the so called “Rockwell hardness”. There are several Rockwell scales for different ranges of hardness. The most common are the B scale (HRB), which is appropriate for soft metals, and the C scale (HRC) for hard metals. The method for measuring hardness according to Rockwell is specified in DIN EN ISO 6508-ASTM E-18. Rockwell hardness numbers are not proportional to Vickers hardness readings, but there exist conversion tables, according to which the above range of 35 to 60 HRC is corresponding a Vickers hardness of between 345 and 687 HV/10.

A very hard host material does not show a buffer effect mentioned above and there is a risk that the preformed carbide particles broke out of the matrix. A too soft host material results in a low wear resistance and low friction resistance.

Best results were found if the difference of hardness of the preformed carbide particles and the hardness of the matrix material is a range of between 500 and 1200 HV/10.

Typically, the weight proportion of the preformed carbide particles in the matrix is in the region between 5 wt.-% and 50 wt.-%, preferably in the region between 15 wt.-% and 40 wt.-%.

The weight proportion of preformed carbide particles in the material according to the invention depends on the hardness of the matrix. A hard matrix material re-quires fewer preformed carbide particles than a soft matrix does.

Besides the weight proportion, essential parameters are the size and number of the preformed carbide particles. Best results were found, where the preformed carbide particles have a mean particle size in the range between 25 μm and 250 μm, preferably in the range between 100 μm and 200 μm.

With respect to a torque-reduction device for use in a drill string, the above mentioned object is achieved by a torque-reducing contact surface of said generally cylindrical body adapted to form part of a drill string made of a material according to the present invention.

The torque-reducing contact surface is provided on a part of the drill string—including protector (means surrounding an inner drill pipe)—or on a part of it which is expected to come frequently into contact with the casing. The torque-reducing contact surface is provided by a matrix of a relatively soft host material in which preformed carbide particles are randomly embedded.

Due to a regular frictional contact with the casing the relative soft matrix is gradually abraded until ultimately some of the hard particles project through the surface. Consequently, the contact area between the casing and the material according to the invention is reduced, resulting in a low coefficient of friction, whereby it is essential that the most of the carbide particles are showing a spherical shape in order to reduce the damage of the casing. On the other hand, the hard carbide particles themselves withstand essentially any abrasion process thus contributing to a high wear resistance of the material all in all. Furthermore, in case of a contact with the casing, the relative soft matrix composition works like a buffer and pre-vents severe damage to the casing, as well as to the drill string.

The above-explained preferred embodiments of the material according to invention can be applied for the material to be used for making the torque-reducing contact surface of a drill string.

The torque-reducing contact surface may be provided by a separate member, which is fixed to the drill string or to a body adapted to form part of a drill string. However, preferably, the contact surface is provided in form of a coating, or in the form of an insert, which is fixed in a recess of the body.

The most economical method of providing the torque-reducing contact surface is in the form of a lamellar coating. By virtue of the invention it is possible to produce coatings having good resistance to wear, as well as having a low coefficient of friction.

Preferably the coating has a thickness in the range of 1 to 10 mm, preferably 2 to 5 mm.

Alternatively, the contact surface is provided in form of an insert, which is fixed in a recess of the body.

Since the insert is firmly attached to the body it does not tend to spall or drop down resulting in an embodiment which is characterized by high reliability. The insert may have a ring-like shape.

In a preferred embodiment, the insert is formed as a ring member that is inserted into the recess of the body.

With respect to the method for producing the material according to the invention the above mentioned object is achieved according to the invention in that melting heat and melting time are chosen such that the host material is molten while the main volume portion of the preformed spherical carbide particles does not undergo solution in the molten host material.

It is known in the art, that carbides precipitate from a melt containing or a solid solution containing large quantities of carbon. However, it was found that a certain quantity of such precipitate s in the material can be allowed, but best results were found if all or at least the greatest part the hard particles are preformed particles dispersed in the host material and showing a spherical shape.

Therefore, in order to avoid a saturation of the melt or the solid solution with such components and subsequent precipitations during cooling, preformed hard particles are dispersed into the host material, thereby allowing a homogeneous distribution as well as the adjustment of a predetermined medium size and size distribution of the hard particles.

Furthermore, such melting or welding techniques are used according to the invention, which do not generate melting conditions (melting heat and melting time) causing the total melting of the preformed carbide particles. In contrast, according to the invention the melting conditions are chosen such that the host material is molten while the main volume portion of the hard particles does not undergo solution in the molten host material. Thus, it is possible to maintain the preformed hard particles' form, amount, size and distribution in the host material.

In this respect, best results were found when the melting of the raw material is accomplished by flame spraying or by plasma transferred arc welding.

Typically, these methods are used to apply coatings on a substrate. Either the melting temperature is low enough or the melting time is short enough (or both is valid), to avoid the complete melting of the hard particles, whereas the host material, exhibiting a relatively low melting temperature is totally in the molten state. Such coating methods are described, for example, in U.S. Pat. No. 6,322,857 A.

Of course, the above described method is adapted at the best possible rate to the material according to the invention which is explained above in more detail.

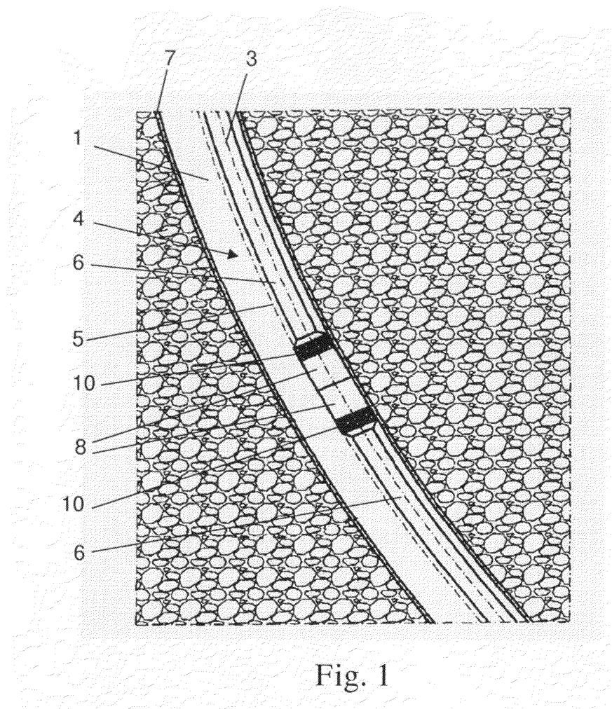

An example embodiment of the invention will now be illustrated with reference to FIG. 1, which illustrates a torque-reduction device for use in a drill string in accordance with the present invention.

Referring to FIG. 1, showing a section of a drill string 4, having a drill bit at the lower end thereof (not shown) which is positioned in a deviated wellbore 1. The drill string 4 is comprised of drill pipe 6 assembled of many joints of pipe that are interconnected together by tool joints 8. The cylinder surface of each of the tool joints 8 is provided with a ring-like wear resistant coating 10, projecting perpendicular to the longitudinal axis 3 as indicated by the dotted line 5. The wall of the wellbore 1 is lined by a metal casing 7.

The ring-like wear resistant coating 10 shows a thickness of about 4 mm and a width (in the direction of the longitudinal axis 3) of about 50 mm. The coating 10 is composed of preformed carbide particles in form of spherical preformed CrC particles which are randomly embedded in a matrix of a Ni based alloy. In the following preferred compositions of the a ring-like wear resistant coating 10 and some preferred manufacture methods are explained with two Examples according of the invention.

### EXAMPLE 1

The volumetric content of the CrC particles having a hardness of about 1500 HV/10 is about 30 vol.-%. The mean particle size of the CrC particles is about 120 μm.

The Ni based alloy accounts for 70 Vol.-% of the total volume. It is an alloy as disclosed in the U.S. Pat. No. 6,027,583 A. Besides nickel it comprises additional constituents in the following alloying ranges (each in wt.-%): C: 0.01-0.5; Cr: 14.0-20.5; Mo: 12.0-18.5; Fe: 0.5-5.0; Si: 3.0-6.5; B: 1.5-3.5 and Cu: 1.5-4.0.

Preferably, the contents of the additional constituents are in the following alloying ranges (each in wt.-%):C: 0.05-0.3; Cr: 15.0-18.0; Mo: 12.0-16.0; Fe: 2.0-4.0; Si: 4.5-5.5; B: 2.0-3.0 and Cu: 2.0-3.0. The Ni based alloy is showing a hard-ness of about 50 HRC.

The coating 10 is provided onto the cylinder surface of each of the tool joints 8 by a flame spraying method using a mixture of two powders, the first one consisting of the preformed CrC particles and the second is alloy powder with the composition given above.

After cleaning the surface of the tool joint 8, it was prepared by blasting with corundum of a grain distribution of between 0.3 and 0.6 mm, and then a layer was sprayed on to it, of a layer thickness of 4 mm, using an autogeneous flame spray torch. After the spraying operation the layer was fused-in with an autogeneous fusing-in torch and slowly cooled down—in order to avoid cracks.

The temperature during the coating process by flame spraying is high enough to obtain a homogeneous melt of the Ni based alloy, but the temperature is low enough to avoid melting of the CrC particles.

### EXAMPLE 2

The volumetric content of the CrC particles having a hardness of about 1500 HV/10 is about 20 vol.-%. The mean particle size of the CrC particles is about 150 μm.

The Ni based alloy accounts for 80 Vol.-% of the total volume. It comprises Ni: 47.75, Cr: 20.5, Mo: 18.5, Si: 4.0, Fe: 1.0, B: 1.5, Cu: 2.0 and C: 0.25. The Ni based alloy is showing a hardness of about 50 HRC.

The coating 10 is provided onto the cylinder surface of each of the tool joints 8 by a plasma transferred arc welding using a mixture of two powders, the first one consisting of the preformed CrC particles and the second is alloy powder with the composition given above. The heating time during the coating process by plasma transferred arc process is long enough to obtain a homogeneous melt of the Ni based alloy, but the heating time is short enough to avoid a complete melting of the CrC particles.

1. A material for producing parts or coatings adapted for highly wear and friction Intensive applications, said material comprising preformed hard material particles made of carbides which are randomly embedded in a matrix of a relatively soft host material, wherein said carbide particles are preformed spherical particles having a hardness in the range between 1000 and 2000 HV/10 and said host material is a Ni based alloy additionally comprising C, Cr, Mo, Fe, Si, B, and Cu in the following ranges (in wt %):

| | |
|---|---|
| C | 0.005-1.0 |
| Cr | 10.0-26.0 |
| Mo | 8.0-22.0 |
| Fe | 0.1-10.0 |
| Si | 3.0-9.0 |
| B | 1.0-5.0 |
| Cu | 0.1-5.0 |

2. A material according to claim 1, wherein the preformed carbide particles have a hardness lower than 1800 HV/10.

3. A material according to claim 1, wherein the host material has a hardness in the range of 35 HRC to 60 HRC.

4. A material according to claim 1, wherein the difference of hardness of the performed carbide particles and the hardness of the host material is a range of between 500 and 1200 HV/10.

5. A material according to claim 1, wherein the preformed carbides particles comprise chromium carbide.

6. A material preceding claims claim 1, wherein the volume proportion of the preformed carbide particles is in a range between 5 vol.-% and 50 vol.-%.

7. A material according to claim 6, wherein the volume proportion of the preformed carbide particles is in a range between 15 wt-% and 40 wt-%.

8. A material according to claim 1, wherein the preformed carbide particles have a mean particle size in the range between 25 μm and 250 μm, preferably in the range between 100 μm and 200 μm.

9. A torque-reduction device for use in a drill string, comprising a generally cylindrical body adapted to form part of a drill string, said body including a torque-reducing contact surface, wherein the contact surface is made of a material according claim 1.

10. A device according to claim 9, wherein the contact surface is provided in the form of a lamellar coating of the body.

11. A device according to claim 10, wherein the coating has a thickness in the range of 1 to 10 mm, preferably 2 to 6 mm.

12. A device according claim 9, wherein the contact surface is provided in the form of an insert which is fixed in a recess of the body.

13. A device according to claim 12, wherein the insert is a ring member.

14. Method for producing a material adapted to form parts or coatings for highly wear and friction intensive applications according to claim 1, by providing a mixture of raw material in powder form or wire form comprising preformed spherical carbide particles and a host material, and subsequent melting of the raw material, wherein melting heat and melting time are chosen such that the host material is molten while the main volume portion of the preformed carbide particles does not undergo solution in the molten host material.

15. Method according to claim 14, wherein the melting of the raw material is accomplished by flame spraying or by plasma transferred arc welding.
